(19) United States
(12) Patent Application Publication
(10) Pub. No.: US 2025/0125077 A1
(43) Pub. Date: Apr. 17, 2025

(54) COIL COMPONENT

(71) Applicant: TDK Corporation, Tokyo (JP)

(72) Inventors: Akira MOTOHASHI, Tokyo (JP); Naoaki FUJII, Tokyo (JP); Tomonaga NISHIKAWA, Tokyo (JP); Masahiro FUKUYAMA, Tokyo (JP)

(21) Appl. No.: 18/911,587

(22) Filed: Oct. 10, 2024

(30) Foreign Application Priority Data
Oct. 12, 2023 (JP) 2023-176435

(51) Int. Cl. H01F 17/00; H01F 27/29

(52) U.S. Cl. CPC H01F 17/0013; H01F 27/292; H01F 2017/002

(57) ABSTRACT

Disclosed herein is a coil component that includes a plurality of conductor layers embedded in a magnetic element The plurality of conductor layers include a first body. conductor layer positioned at one end portion in a stacking direction, a second conductor layer positioned at another end portion in the stacking direction, and one or more third conductor layers positioned between the first and second conductor layers. The first conductor layer includes a first coil pattern and first and second connection patterns exposed from the mounting surface. The second and third conductor layers include second and third coil patterns, respectively, and third and fourth connection patterns, respectively, exposed from the mounting surface. The magnetic element body is disposed in an end area that overlaps the first connection pattern in a plan view as viewed in the stacking direction.

### CROSS-REFERENCE TO RELATED APPLICATION

This application claims the benefit of Japanese Patent Application No. 2023-176435, filed on Oct. 12, 2023, the entire disclosure of which is incorporated by reference herein.

### BACKGROUND OF THE ART

### Field of the Art

The present disclosure relates to a coil component and, more particularly, to a coil component having a structure in which a plurality of conductor layers stacked through an insulating resin layer are embedded in a magnetic element body.

### Description of Related Art

JP 2022-152043A discloses a coil component having a structure in which a plurality of conductor layers stacked through an insulating resin layer are embedded in a magnetic element body. In the coil component disclosed in JP 2022-152043A, each conductor layer includes a coil pattern and a pair of connection patterns exposed from the magnetic element body.

To increase the inductance of the coil component, it is effective to increase the volume of the magnetic element body.

### SUMMARY

The present disclosure describes a technology for increasing the inductance of a coil component having a structure in which a plurality of conductor layers stacked through an insulating resin layer are embedded in a magnetic element body by increasing the volume of the magnetic element body.

A coil component according to one aspect of the present disclosure includes a magnetic element body having a mounting surface, a plurality of conductor layers embedded in the magnetic element body and stacked through an insulating resin layer, and first and second terminal electrodes. The plurality of conductor layers include a first conductor layer positioned at one end portion in the stacking direction, a second conductor layer positioned at the other end portion in the stacking direction, and one or more third conductor layers positioned between the first and second conductor layers. The first conductor layer includes a first coil pattern having a coil axis extending in parallel to the mounting surface, a first connection pattern exposed from the mounting surface and connected to the outer peripheral end of the first coil pattern, and a second connection pattern exposed from the mounting surface and separated from the first coil pattern in the same surface. The second conductor layer includes a second coil pattern having a coil axis extending in parallel to the mounting surface and a third connection pattern exposed from the mounting surface and connected to the outer peripheral end of the second coil pattern. The third conductor layer includes a third coil pattern having a coil axis extending in parallel to the mounting surface and a fourth connection pattern exposed from the mounting surface and separated from the third coil pattern in the same surface. The second, third, and fourth connection patterns overlap one another in a plan view (as viewed in the stacking direction) and connected to one another through a via hole formed in the insulating resin layer. The first terminal electrode is provided on the mounting surface so as to contact the first connection pattern, and the second terminal electrode is provided on the mounting surface so as to contact the second, third, and fourth connection patterns. In at least the second conductor layer, the magnetic element body is disposed in an end area that overlaps the first connection pattern in a plan view (as viewed in the stacking direction). With this configuration, the volume of the magnetic element body can be increased.

### BRIEF DESCRIPTION OF THE DRAWINGS

The above features and advantages of the present disclosure will be more apparent from the following description of certain embodiments taken in conjunction with the accompanying drawings, in which:

FIG. 1A is a schematic perspective view illustrating the outer appearance of a coil component 100 according to an embodiment of the present disclosure;

FIG. 1B is a schematic perspective view illustrating a state where terminal electrodes 131 and 132 have been removed from the coil component 100;

FIG. 2 is a schematic plan view explaining the structure of the conductor layer L1;

FIG. 3 is a schematic plan view explaining the structure of the conductor layer L2;

FIG. 4 is a schematic plan view explaining the structure of the conductor layer L3;

FIG. 5 is a schematic plan view explaining the structure of the conductor layer L4;

FIG. 6 is a schematic plan view explaining the structure of the conductor layer L5;

FIG. 7 is a schematic plan view explaining the structure of the conductor layer L6;

FIG. 8 is a schematic perspective view illustrating the outer appearance of a coil component according to a first modification, which illustrates a state in which the terminal electrodes 131 and 132 have been removed;

FIG. 9 is a schematic perspective view illustrating the outer appearance of a coil component according to a second modification, which illustrates a state in which the terminal electrodes 131 and 132 have been removed;

FIG. 10 is a schematic perspective view illustrating the outer appearance of a coil component according to a third modification, which illustrates a state in which the terminal electrodes 131 and 132 have been removed; and

FIG. 11 is a schematic perspective view illustrating the outer appearance of a coil component according to a fourth modification, which illustrates a state in which the terminal electrodes 131 and 132 have been removed.

### DETAILED DESCRIPTION OF THE EMBODIMENTS

Some embodiments of the present disclosure will be explained below in detail with reference to the accompanying drawings.

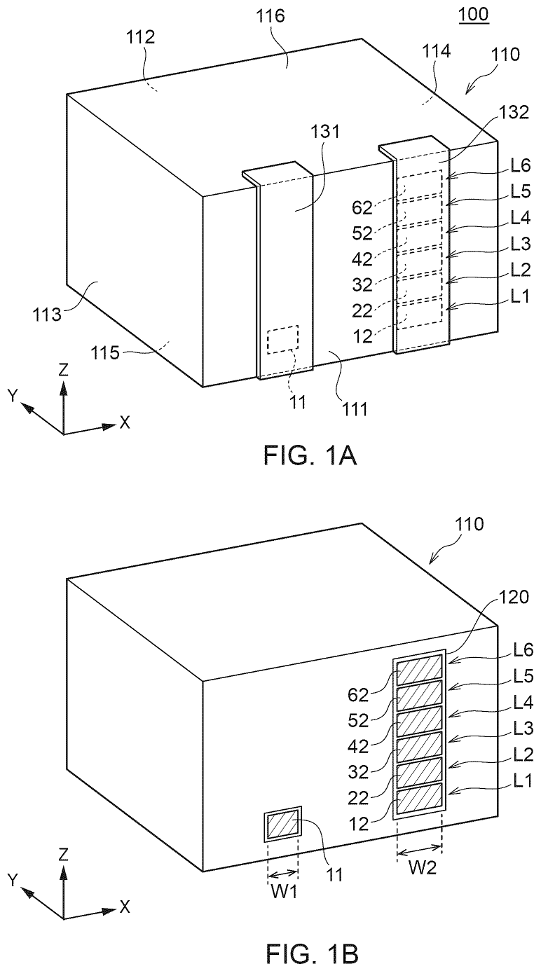

FIG. 1A is a schematic perspective view illustrating the outer appearance of a coil component 100 according to an embodiment of the present disclosure. FIG. 1B is a schematic perspective view illustrating a state where terminal electrodes 131 and 132 have been removed from the coil component 100 according to the present embodiment.

As illustrated in FIGS. 1A and 1B, the coil component 100 according to the present embodiment includes a magnetic element body 110 made of a composite material containing magnetic fillers made of a metal magnetic body and a resin binder and a plurality of conductor layers L1 to L6 embedded in the magnetic element body 110 and stacked through an insulating resin layer 120. Conductor patterns respectively provided in the conductor layers L1 to L6 and the magnetic element body 110 are insulated from each other by the insulating resin layer 120. The conductor patterns of the respective conductor layers L1 to L6 are made of a good conductor such as Cu (copper). The insulating resin layer 120 is made of non-magnetic insulating resin.

The coil component 100 according to the present embodiment is an embedded type coil component having a structure in which the insulating resin layer 120 and the conductor layers L1 to L6 are embedded in the magnetic element body 110 and differs in structure from a stacked type coil component having a magnetic sheet made of a ceramic material and a coil pattern which are alternately stacked. For example, in the stacked type coil component, a magnetic sheet is interposed between coil patterns adjacent in the stacking direction; on the other hand, in the coil component 100 according to the present embodiment, coil patterns adjacent in the stacking direction are insulated by the insulating resin layer 120, and the magnetic element body 110 is not interposed therebetween. The coil component 100 according to the present embodiment also differs in structure from a sheet coil of a type having a coil pattern on a printed board.

The magnetic element body 110 has surfaces 111 and 112 constituting the XZ surface and positioned on opposite sides to each other, surfaces 113 and 114 constituting the YZ surface and positioned on the opposite sides to each other, and surfaces 115 and 116 constituting the XY surface and positioned on opposite sides to each other. The surface 111 constitutes a mounting surface facing the surface of a circuit board in actual use state. The Z-direction is the stacking direction of the conductor layers L1 to L6. That is, in the coil component 100 according to the present embodiment, the mounting surface is parallel to the stacking direction.

There are exposed, from the mounting surface 111, connection patterns 11 and 12 positioned in the conductor layer L1, a connection pattern 22 positioned in the conductor layer L2, a connection pattern 32 positioned in the conductor layer L3, a connection pattern 42 positioned in the conductor layer L4, a connection pattern 52 positioned in the conductor layer L5, and a connection pattern 62 positioned in the conductor layer L6. The terminal electrode 131 is provided on the mounting surface 111 so as to contact the connection pattern 11. The terminal electrode 132 is provided on the mounting surface 111 so as to contact the connection patterns 12, 22, 32, 42, 52, and 62. In the example illustrated in FIG. 1B, an exposure width W1 in the horizontal direction (X-direction) of the connection pattern 11 exposed from the mounting surface 111 is smaller than an exposure width W2 in the horizontal direction (X-direction) of each of the connection patterns 12, 22, 32, 42, 52, and 62 exposed from the mounting surface 111.

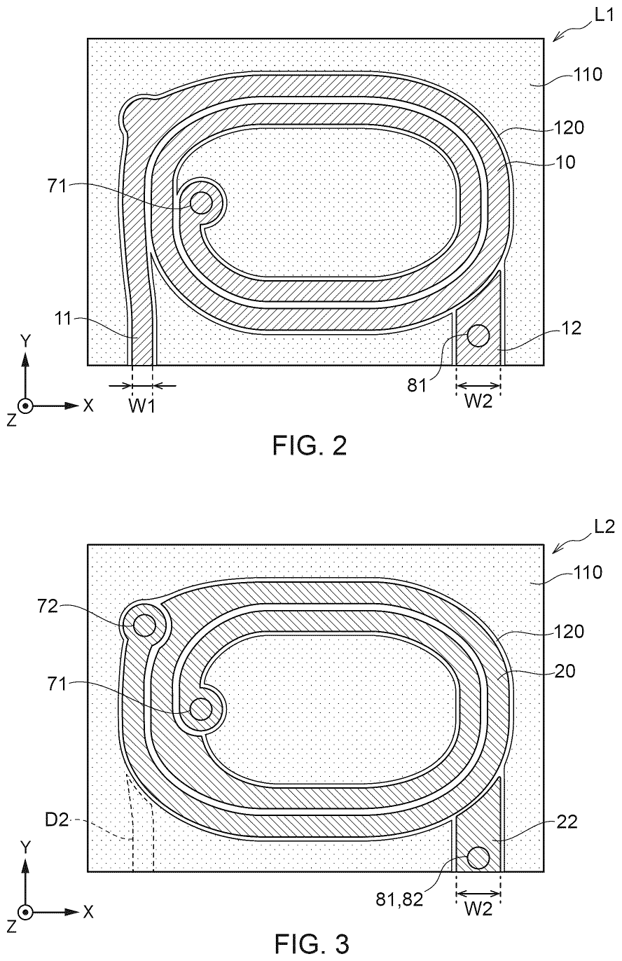

FIGS. 2 to 7 are schematic plan views respectively explaining the structures of the conductor layers L1 to L6.

As illustrated in FIG. 2, the conductor layer L1 has a coil pattern 10 and the connection patterns 11 and 12. The magnetic element body 110 is disposed, through the insulating resin layer 120, in the inner diameter area (area surrounded by the coil pattern 10) of the coil pattern 10 and the outside area (area positioned radially outside the coil pattern 10) of the coil pattern 10. The coil pattern 10 is wound in about two turns, and adjacent turns thereof are insulated by the insulating resin layer 120. The outer peripheral end of the coil pattern 10 is connected to the connection pattern 11. The connection pattern 11 is a part of the coil pattern 10 that is positioned in the vicinity of the outer peripheral end thereof, which extends in the negative Y-direction so as to be separated from the radially inner turn. That is, the connection pattern 11 is a part of the coil pattern 10 that is sandwiched by the magnetic element body 110 through the insulating resin layer 120 from both sides in the width direction (X-direction). The connection pattern 12 is not connected to the coil pattern 10 in the same surface and independent therein. The coil pattern 10 and the connection pattern 12 are separated from each other through the insulating resin layer 120.

As illustrated in FIG. 3, the conductor layer L2 has a coil pattern 20 and the connection pattern 22. The magnetic element body 110 is disposed, through the insulating resin layer 120, in the inner diameter area (area surrounded by the coil pattern 20) of the coil pattern 20 and the outside area (area positioned radially outside the coil pattern 20) of the coil pattern 20. The coil pattern 20 is wound in about two turns, and adjacent turns thereof are insulated by the insulating resin layer 120. The inner peripheral end of the coil pattern 20 is connected to the inner peripheral end of coil pattern 10 through a via hole 71 formed in the insulating resin layer 120. The connection pattern 22 is not connected to the coil pattern 10 in the same surface and independent therein and is connected to the connection pattern 12 through a via hole 81 formed in the insulating resin layer 120. The coil pattern 20 and the connection pattern 22 are separated from each other through the insulating resin layer 120. In the conductor layer L2, a part of the magnetic element body 110 that overlaps the connection pattern 11 of the conductor layer L1 in a plan view (as viewed in the Z-direction) constitutes an end area D2.

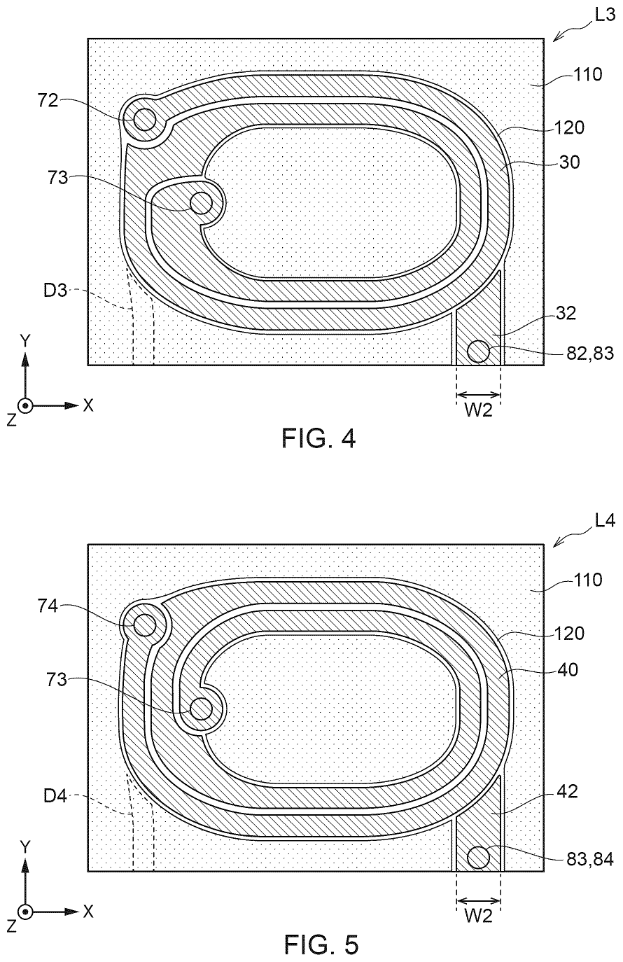

As illustrated in FIG. 4, the conductor layer L3 has a coil pattern 30 and the connection pattern 32. The magnetic element body 110 is disposed, through the insulating resin layer 120, in the inner diameter area (area surrounded by the coil pattern 30) of the coil pattern 30 and the outside area (area positioned radially outside the coil pattern 30) of the coil pattern 30. The coil pattern 30 is wound in about two turns, and adjacent turns thereof are insulated by the insulating resin layer 120. The outer peripheral end of the coil pattern 30 is connected to the outer peripheral end of coil pattern 20 through a via hole 72 formed in the insulating resin layer 120. The connection pattern 32 is not connected to the coil pattern 30 in the same surface and independent therein and is connected to the connection pattern 22 through a via hole 82 formed in the insulating resin layer 120. The coil pattern 30 and connection pattern 32 are separated from each other through the insulating resin layer 120. In the conductor layer L3, a part of the magnetic element body 110 that overlaps the connection pattern 11 of the conductor layer L1 in a plan view (as viewed in the Z-direction) constitutes an end area D3.

As illustrated in FIG. 5, the conductor layer L4 has a coil pattern 40 and the connection pattern 42. The magnetic element body 110 is disposed, through the insulating resin layer 120, in the inner diameter area (area surrounded by the coil pattern 40) of the coil pattern 40 and the outside area (area positioned radially outside the coil pattern 40) of the coil pattern 40. The coil pattern 40 is wound in about two turns, and adjacent turns thereof are insulated by the insulating resin layer 120. The inner peripheral end of the coil pattern 40 is connected to the inner peripheral end of coil pattern 30 through a via hole 73 formed in the insulating resin layer 120. The connection pattern 42 is not connected to the coil pattern 40 in the same surface and independent therein and is connected to the connection pattern 32 through a via hole 83 formed in the insulating resin layer 120. The coil pattern 40 and connection pattern 42 are separated from each other through the insulating resin layer 120. In the conductor layer L4, a part of the magnetic element body 110 that overlaps the connection pattern 11 of the conductor layer L1 in a plan view (as viewed in the Z-direction) constitutes an end area D4.

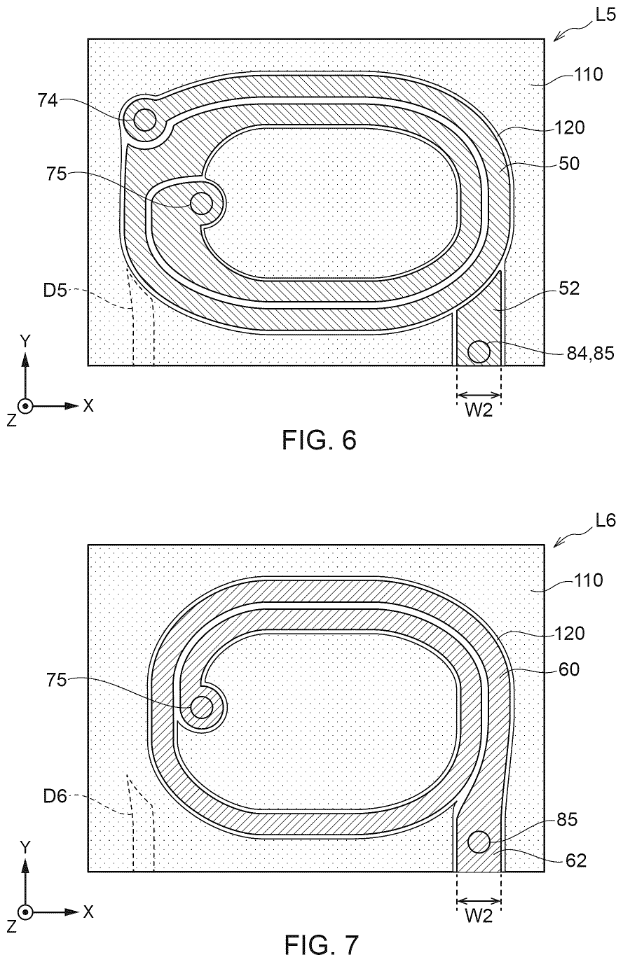

As illustrated in FIG. 6, the conductor layer L5 has a coil pattern 50 and the connection pattern 52. The magnetic element body 110 is disposed, through the insulating resin layer 120, in the inner diameter area (area surrounded by the coil pattern 50) of the coil pattern 50 and the outside area (area positioned radially outside the coil pattern 50) of the coil pattern 50. The coil pattern 50 is wound in about two turns, and adjacent turns thereof are insulated by the insulating resin layer 120. The outer peripheral end of the coil pattern 50 is connected to the outer peripheral end of coil pattern 40 through a via hole 74 formed in the insulating resin layer 120. The connection pattern 52 is not connected to the coil pattern 50 in the same surface and independent therein and is connected to the connection pattern 42 through a via hole 84 formed in the insulating resin layer 120. The coil pattern 50 and connection pattern 52 are separated from each other through the insulating resin layer 120. In the conductor layer L5, a part of the magnetic element body 110 that overlaps the connection pattern 11 of the conductor layer L1 in a plan view (as viewed in the Z-direction) constitutes an end area D5.

As illustrated in FIG. 7, the conductor layer L6 has a coil pattern 60 and the connection pattern 62. The magnetic element body 110 is disposed, through the insulating resin layer 120, in the inner diameter area (area surrounded by the coil pattern 60) of the coil pattern 60 and the outside area (area positioned radially outside the coil pattern 60) of the coil pattern 60. The coil pattern 60 is wound in about 1.5 turns, and adjacent turns thereof are insulated by the insulating resin layer 120. The outer peripheral end of the coil pattern 60 is connected to the connection pattern 62. The connection pattern 62 is a part of the coil pattern 60 that is positioned in the vicinity of the outer peripheral end thereof, which extends in the negative Y-direction so as to be separated from the radially inner turn. That is, the connection pattern 62 is a part of the coil pattern 60 that is sandwiched by the magnetic element body 110 through the insulating resin layer 120 from both sides in the width direction (X-direction). The connection pattern 62 is connected to the connection pattern 52 through a via hole 85 formed in the insulating resin layer 120. The inner peripheral end of the coil pattern 60 is connected to the inner peripheral turn of the coil pattern 50 through a via hole 75 formed in the insulating resin layer 120. In the conductor layer L6, a part of the magnetic element body 110 that overlaps the connection pattern 11 of the conductor layer L1 in a plan view (as viewed in the Z-direction) constitutes an end area D6.

As illustrated in FIGS. 1A and 1B, the connection patterns 12, 22, 32, 42, 52, and 62 overlap one another in a plan view (as viewed in the Z-direction) and are all exposed from the surface 111 of the magnetic element body 110. On the other hand, no conductor pattern is disposed in the end areas D2 to D6 that overlap the connection pattern 11 in a plan view (as viewed in the Z-direction) and, instead, the magnetic element body 110 is disposed therein. Thus, as compared with a case where the end areas D2 to D6 are filled with the conductor pattern, the volume of the magnetic element body 110 positioned in the conductor layers L2 to L6 increases, making it possible to achieve high inductance. The increase in volume of the magnetic element body 110 also reduces leakage flux.

In addition, the exposure width W1 of the connection pattern 11 is smaller than the exposure width W2 of each of the connection patterns 12, 22, 32, 42, 52, and 62, so that the volume of the magnetic element body 110 that is positioned in the conductor layer L1 also increases. On the other hand, the exposure width W2 of each of the connection patterns 12, 22, 32, 42, 52, and 62 needs to be relatively large since it is necessary to form the via holes 81 to 85 therein.

In manufacturing the coil component 100 according to the present embodiment, the insulating resin layer 120 and the conductor layers L1 to L6 are alternately stacked in this order, and then the magnetic element body 110 is filled in a space having neither the insulating resin layer 120 nor conductor layers L1 to L6, whereby the coil component 100 is completed. In this case, some kind of foundation for forming the connection pattern 62 positioned in the conductor layer L6 is required in the conductor layers L1 to L5 positioned below the connection pattern 62. In this embodiment, the connection patterns 12, 22, 32, 42, and 52 function as the foundation for the connection pattern 62. Further, the connection patterns 12, 22, 32, 42, and 52 are connected to the connection pattern 62 through the via holes 81 to 85 to thereby act to reduce a resistance value between the terminal electrode 132 and the coil pattern 60.

As described above, in the coil component 100 according to the present embodiment, no conductor pattern is disposed in the end areas D2 to D6 that overlap the connection pattern 11 constituting the outer peripheral end of the coil pattern 10 positioned in the lowermost layer and, instead, the magnetic element body 110 is filled therein. Thus, the volume of the magnetic element body 110 increases, with the result that high inductance can be achieved.

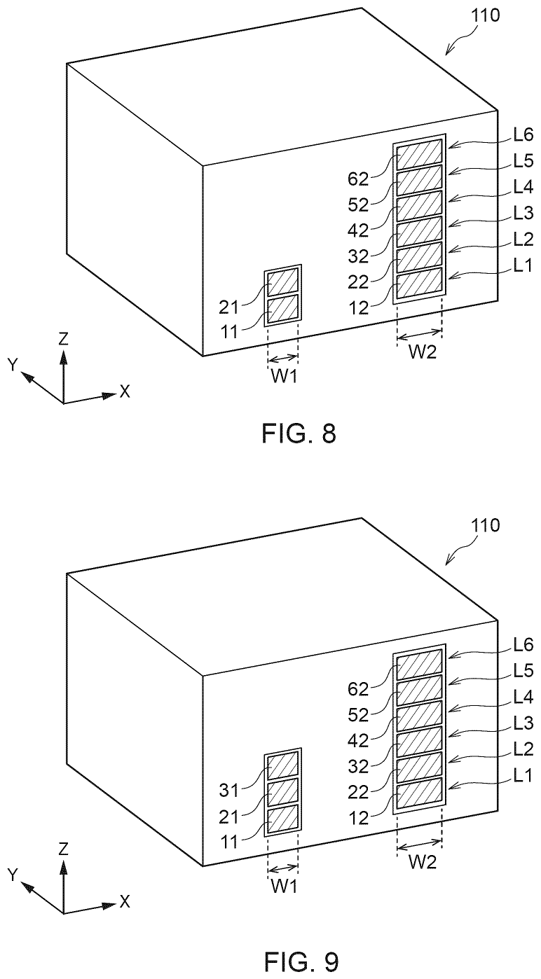

FIG. 8 is a schematic perspective view illustrating the outer appearance of a coil component according to a first modification, which illustrates a state in which the terminal electrodes 131 and 132 have been removed.

The coil component according to the first modification illustrated in FIG. 8 differs from the coil component 100 according to the above embodiment in that a connection pattern 21 is additionally provided in the conductor layer L2. The connection pattern 21 is disposed in the end area D2 illustrated in FIG. 3. That is, the connection pattern 21 overlaps the connection pattern 11 in a plan view (as viewed in the Z-direction). The connection pattern 21 is not connected to the coil pattern 20 in the same surface and independent therein and is connected to the connection pattern 11 through a via hole formed in the insulating resin layer 120. As in the first modification, the connection pattern 21 may be disposed in the end area D2 of the conductor layer L2. With this configuration, the terminal electrode 131 contacts the two connection patterns 11 and 21, thereby increasing the connection reliability of the terminal electrode 131.

FIG. 9 is a schematic perspective view illustrating the outer appearance of a coil component according to a second modification, which illustrates a state in which the terminal electrodes 131 and 132 have been removed.

The coil component according to the second modification illustrated in FIG. 9 differs from the coil component 100 according to the above embodiment in that connection patterns 21 and 31 are additionally provided in the conductor layers L2 and L3, respectively. The connection pattern 21 is disposed in the end area D2 illustrated in FIG. 3. That is, the connection pattern 21 overlaps the connection pattern 11 in a plan view (as viewed in the Z-direction). The connection pattern 21 is not connected to the coil pattern 20 in the same surface and independent therein and is connected to the connection pattern 11 through a via hole formed in the insulating resin layer 120. The connection pattern 31 is disposed in the end area D3 illustrated in FIG. 4. That is, the connection pattern 31 overlaps the connection pattern 11 in a plan view (as viewed in the Z-direction). The connection pattern 31 is not connected to the coil pattern 30 in the same surface and independent therein and is connected to the connection pattern 21 through a via hole formed in the insulating resin layer 120. As in the second modification, the connection pattern may be provided in a plurality of the end areas (end areas D2 and D3 in the example of FIG. 9) as long as the number of the connection patterns (connection patterns 11, 21, and 31 in the example of FIG. 9) connected to the terminal electrode 131 is smaller than the number of the connection patterns (connection patterns 12, 22, 32, 42, 52, and 62 in the example of FIG. 9) connected to the terminal electrode 132.

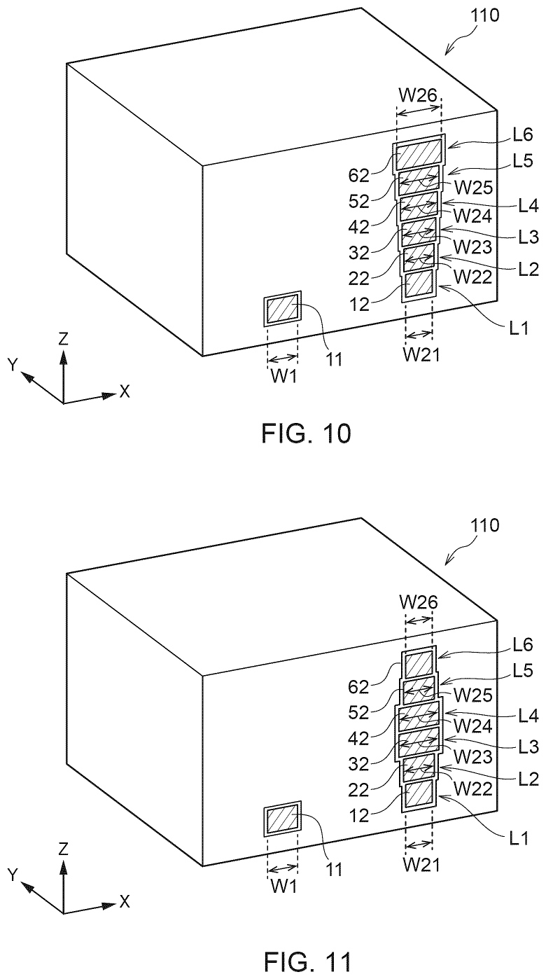

FIG. 10 is a schematic perspective view illustrating the outer appearance of a coil component according to a third modification, which illustrates a state in which the terminal electrodes 131 and 132 have been removed.

The coil component according to the third modification illustrated in FIG. 10 differs from the coil component 100 according to the above embodiment in that exposure widths W21, W22, W23, W24, W25, and W26 in the X-direction of the respective connection patterns 12, 22, 32, 42, 52, and 62 have a relation of W21<W22<W23<W24<W25<W26. As in the third modification, the exposure width of the connection pattern contacting the terminal electrode 132 may be increased toward the upper layer. This can further increase the volume of the magnetic element body 110. Further, a resistance value between the terminal electrode 132 and the coil pattern 60 depends more strongly on the exposure width of the connection pattern toward the upper layer and thus hardly increases even in the structure illustrated in FIG. 10.

FIG. 11 is a schematic perspective view illustrating the outer appearance of a coil component according to a fourth modification, which illustrates a state in which the terminal electrodes 131 and 132 have been removed.

The coil component according to the fourth modification illustrated in FIG. 11 differs from the coil component 100 according to the above embodiment in that exposure widths W21, W22, W23, W24, W25, and W26 in the X-direction of the respective connection patterns 12, 22, 32, 42, 52, and 62 have a relation of W21<W22<W23 and W26<W25<W24. As in the fourth modification, the exposure width of the connection pattern contacting the terminal electrode 132 may be reduced from the center in the stacking direction toward the upper and lower layers. Thus, in the vicinity of the surface 111 constituting the mounting surface, a part of the magnetic element body 110 that is positioned around both end portions thereof in the stacking direction can be increased in volume. In the vicinity of the mounting surface, the magnetic element body 110 becomes higher in magnetic flux density toward both end portions thereof in the stacking direction, making it possible to achieve higher inductance in the modification illustrated in FIG. 11.

While some embodiments of the present disclosure has been described, the present disclosure is not limited to the above embodiments, and various modifications may be made within the scope of the present disclosure, and all such modifications are included in the present disclosure.

For example, although six conductor layers L1 to L6 are stacked in the above embodiment, the number of the conductor layers is not particularly limited, and the number of the conductor layers may be, e.g., four.

The technology according to the present disclosure includes the following configuration examples, but not limited thereto.

A coil component according to one aspect of the present disclosure includes a magnetic element body having a mounting surface, a plurality of conductor layers embedded in the magnetic element body and stacked through an insulating resin layer, and first and second terminal electrodes. The plurality of conductor layers include a first conductor layer positioned at one end portion in the stacking direction, a second conductor layer positioned at the other end portion in the stacking direction, and one or more third conductor layers positioned between the first and second conductor layers. The first conductor layer includes a first coil pattern having a coil axis extending in parallel to the mounting surface, a first connection pattern exposed from the mounting surface and connected to the outer peripheral end of the first coil pattern, and a second connection pattern exposed from the mounting surface and separated from the first coil pattern in the same surface. The second conductor layer includes a second coil pattern having a coil axis extending in parallel to the mounting surface and a third connection pattern exposed from the mounting surface and connected to the outer peripheral end of the second coil pattern. The third conductor layer includes a third coil pattern having a coil axis extending in parallel to the mounting surface and a fourth connection pattern exposed from the mounting surface and separated from the third coil pattern in the same surface. The second, third, and fourth connection patterns overlap one another in a plan view (as viewed in the stacking direction) and connected to one another through a via hole formed in the insulating resin layer. The first terminal electrode is provided on the mounting surface so as to contact the first connection pattern, and the second terminal electrode is provided on the mounting surface so as to contact the second, third, and fourth connection patterns. In at least the second conductor layer, the magnetic element body is disposed in an end area that overlaps the first connection pattern in a plan view (as viewed in the stacking direction). With this configuration, the volume of the magnetic element body can be increased.

In the above coil component, the number of the third conductor layers may be two or more, and in each of the plurality of third conductor layers, the magnetic element body may be disposed in the end area that overlaps the first connection pattern in a plan view (as viewed in the stacking direction). This further increases the volume of the magnetic element body.

In the above coil component, the number of the third conductor layers may be two or more, and at least one of the plurality of the third conductor layers that is adjacent to the first conductor layer may further include a fifth connection pattern that is separated from the third coil pattern in the same surface and overlaps the first connection pattern in a plan view (as viewed in the stacking direction).

The first and fifth connection patterns may be connected to each other through a via hole formed in the insulating resin layer. The first terminal electrode may be provided on the mounting surface so as to contact the first and fifth connection patterns. This can increase the contact area between the first terminal electrode and the connection pattern.

In the above coil component, the exposure width of the first connection pattern exposed from the mounting surface in a horizontal direction perpendicular to the stacking direction may be smaller than the exposure width in the horizontal direction of the third conductor pattern exposed from the mounting surface. This further increases the volume of the magnetic element body.

In the above coil component, the exposure width of the second connection pattern exposed from the mounting surface in a horizontal direction perpendicular to the stacking direction may be smaller than the exposure width in the horizontal direction of the third conductor pattern exposed from the mounting surface. This further increases the volume of the magnetic element body.

In the above coil component, the exposure width of each of the second and third connection patterns exposed from the mounting surface in a horizontal direction perpendicular to the stacking direction may be smaller than the exposure width of in the horizontal direction of the fourth connection pattern exposed from the mounting surface. This further increases inductance.

What is claimed is:

1. A coil component comprising:
a magnetic element body having a mounting surface;
a plurality of conductor layers embedded in the magnetic element body and stacked through an insulating resin layer; and
first and second terminal electrodes,
wherein the plurality of conductor layers include a first conductor layer positioned at one end portion in a stacking direction, a second conductor layer positioned at another end portion in the stacking direction, and one or more third conductor layers positioned between the first and second conductor layers,
wherein the first conductor layer includes a first coil pattern having a coil axis extending in parallel to the mounting surface, a first connection pattern exposed from the mounting surface and connected to an outer peripheral end of the first coil pattern, and a second connection pattern exposed from the mounting surface and separated from the first coil pattern in a same surface;
wherein the second conductor layer includes a second coil pattern having a coil axis extending in parallel to the mounting surface and a third connection pattern exposed from the mounting surface and connected to an outer peripheral end of the second coil pattern,
wherein the third conductor layer includes a third coil pattern having a coil axis extending in parallel to the mounting surface and a fourth connection pattern exposed from the mounting surface and separated from the third coil pattern in a same surface,
wherein the second, third, and fourth connection patterns overlap one another in a plan view as viewed in the stacking direction and connected to one another through a via hole formed in the insulating resin layer,
wherein the first terminal electrode is provided on the mounting surface so as to contact the first connection pattern,
wherein the second terminal electrode is provided on the mounting surface so as to contact the second, third, and fourth connection patterns, and
wherein, in at least the second conductor layer, the magnetic element body is disposed in an end area that overlaps the first connection pattern in a plan view as viewed in the stacking direction.

2. The coil component as claimed in claim 1,
wherein a plurality of the third conductor layers are provided, and wherein, in each of the plurality of third conductor layers, the magnetic element body is disposed in an end area that overlaps the first connection pattern in a plan view as viewed in the stacking direction.

3. The coil component as claimed in claim 1,
wherein a plurality of the third conductor layers are provided,
wherein at least one of the plurality of the third conductor layers that is adjacent to the first conductor layer further includes a fifth connection pattern that is separated from the third coil pattern in a same surface and overlaps the first connection pattern in a plan view as viewed in the stacking direction,
wherein the first and fifth connection patterns are connected to each other through a via hole formed in the insulating resin layer, and
wherein the first terminal electrode is provided on the mounting surface so as to contact the first and fifth connection patterns.

4. The coil component as claimed in claim 1, wherein an exposure width of the first connection pattern exposed from the mounting surface in a horizontal direction perpendicular to the stacking direction is smaller than an exposure width in the horizontal direction of the third conductor pattern exposed from the mounting surface.

5. The coil component as claimed in claim 1, wherein an exposure width of the second connection pattern exposed from the mounting surface in a horizontal direction perpendicular to the stacking direction is smaller than an exposure width in the horizontal direction of the third conductor pattern exposed from the mounting surface.

6. The coil component as claimed in claim 1, wherein an exposure width of each of the second and third connection patterns exposed from the mounting surface in a horizontal direction perpendicular to the stacking direction is smaller than an exposure width in the horizontal direction of the fourth connection pattern exposed from the mounting surface.
